(19) United States
(12) Patent Application Publication
(10) Pub. No.: US 2019/0018407 A1
(43) Pub. Date: Jan. 17, 2019

(54) CONTROL APPARATUS, AERIAL-VEHICLE CONTROL METHOD, AND STORAGE MEDIUM

(71) Applicant: FUJITSU LIMITED, Kawasaki-shi (JP)

(72) Inventors: Motonori INUI, Kawasaki (JP); HIROYUKI SASAI, Shinjuku (JP); Nobuyuki Nuimura, Kawasaki (JP)

(73) Assignee: FUJITSU LIMITED, Kawasaki-shi (JP)

(21) Appl. No.: 16/030,051

(22) Filed: Jul. 9, 2018

(30) Foreign Application Priority Data
Jul. 12, 2017 (JP) 2017-135861

(51) Int. Cl. G05D 1/00; H04W 72/04; H04W 4/40

(52) U.S. Cl. CPC G05D 1/0022; H04W 84/12; H04W 4/40; H04W 72/0453

(57) ABSTRACT

A control apparatus includes a memory; and a processor coupled to the memory and configured to select, from among a plurality of wireless sections that exist in a flight range from when an aerial vehicle flies from a departure place until the aerial vehicle arrives at a destination, a flight wireless section where wireless communication is connectable from the departure place to the destination; and reserve, with wireless base stations that are located in the flight wireless section, a communication band for performing wireless communication with the aerial vehicle.

### CROSS-REFERENCE TO RELATED APPLICATION

This application is based upon and claims the benefit of priority of the prior Japanese Patent Application No. 2017-135861, filed on Jul. 12, 2017, the entire contents of which are incorporated herein by reference.

### FIELD

The embodiments discussed herein are related to a control apparatus, an aerial-vehicle control method, and a storage medium.

### BACKGROUND

In recent years, technology for small unmanned aerial vehicles called drones have advanced, and the drones are expected to be used in fields of logistics, aerial photography, measurement, and so on. Under the present situation, the flight range of each drone is, in many cases, a flight range within a visual observation area in order to wirelessly control the drone by using an operation terminal using a wireless local area network (LAN).

For example, when a drone is flown using a wireless LAN based on the Institute Electrical and Electronics Engineers (IEEE) 802.11 standard, the flight range of about 200 to 300 m is controllable with a 2.4 GHz band. For example, Japanese Laid-open Patent Publication No. 2017-055335 has been disclosed as Related art.

For realizing a variety of services utilizing drones, there are demands for a technology for flight control using radio waves of wireless base stations, in order to fly drones over a wide range. When a drone is flown in a wide range by performing wireless communication between the drone and a wireless base station, and communication band resources for wireless communication during flight of the drone become insufficient, for example, there is a risk in that the drone loses control and crashes. Thus, it is important that a communication band for performing wireless communication with the drone be ensured with the wireless base station to thereby ensure flight safety of the drone.

### SUMMARY

According to an aspect of the invention, a control apparatus includes a memory; and a processor coupled to the memory and configured to select, from among a plurality of wireless sections that exist in a flight range from when an aerial vehicle flies from a departure place until the aerial vehicle arrives at a destination, a flight wireless section where wireless communication is connectable from the departure place to the destination; and reserve, with wireless base stations that are located in the flight wireless section, a communication band for performing wireless communication with the aerial vehicle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a control apparatus;

FIG. 2 is a diagram illustrating an example of the configuration of a flight management system;

FIG. 3 is a diagram illustrating an example of the configuration of the flight management system;

FIG. 4 is a diagram illustrating an example of the hardware configuration of a flight control apparatus;

FIG. 5 is a diagram illustrating an example of functional blocks;

FIG. 6 is a diagram illustrating an example of functional blocks in a flight control apparatus;

FIG. 7 illustrates examples of tables stored in a flight-plan information manager and a base-station information manager;

FIG. 8 illustrates an example of an operation flowchart of the flight management system;

FIG. 9 illustrates an example of a flight condition management table;

FIG. 10 illustrates an example of a cell data management table;

FIG. 11 is a diagram illustrating an example of cell connections;

FIG. 12 is a table illustrating an example of management of cell connection information;

FIG. 13 illustrates an example of management of the cell connection information;

FIG. 14 illustrates an example of a flight route management table;

FIG. 15 is a table for describing generation of a base-station reservation information management table;

FIG. 16 is a diagram illustrating an example in which distances from a departure place are set on a flight route;

FIG. 17 illustrates a registration example of the base-station reservation information management table;

FIG. 18 is a diagram illustrating an example of setting of reservation times of communication bands;

FIG. 19 illustrates an example of a reservation time management table;

FIG. 20 illustrates an example of a cell-specific communication band reservation management table;

FIG. 21 is a flowchart illustrating an operation of flight plan calculation;

FIG. 22 is a flowchart illustrating an operation of the flight plan calculation;

FIG. 23 is a flowchart illustrating an operation for re-calculating a flight plan; and

FIG. 24 is a flowchart illustrating an operation of drone automatic flight control.

### DESCRIPTION OF EMBODIMENTS

Embodiments of the present disclosure will be described below with reference to the accompanying drawings.

### First Embodiment

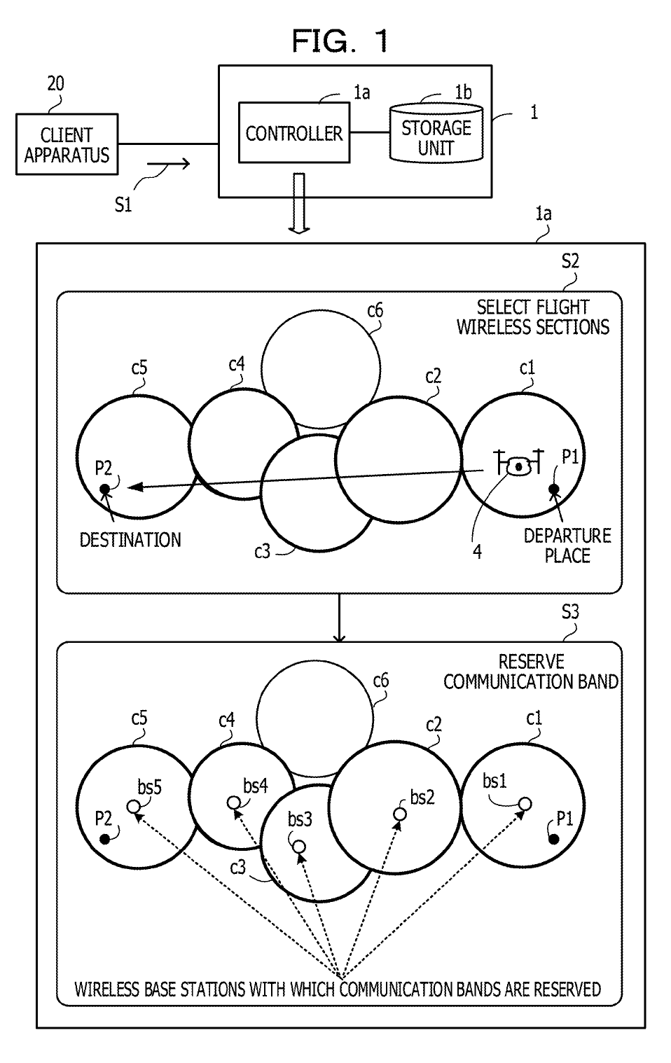

A control apparatus in a first embodiment will be described with reference to FIG. 1. FIG. 1 is a diagram illustrating an example of the configuration of a control apparatus. A control apparatus 1 includes a controller 1a and a storage unit 1b.

The controller 1a selects, in a plurality of wireless sections that exist in a flight range from when an aerial vehicle flies from a departure place until the aerial vehicle arrives at a destination, flight wireless sections where wireless communication is connectable from the departure place to the destination. The controller la then reserves, with wireless base stations that are located in the flight wireless sections, communication bands for performing wireless communication with the aerial vehicle and performs flight control on the aerial vehicle. The storage unit 1b stores therein identification information of the flight wireless sections, location information of the wireless base stations, information used for a flight plan and flight control of the aerial vehicle.

An operation of the controller la will now be described in conjunction with the example illustrated in FIG. 1. Wireless sections c1, . . . , and c6 exist in a flight range from when an aerial vehicle 4 flies from a departure place P1 until the aerial vehicle 4 arrives at a destination P2. The departure place P1 is included in the wireless section c1, and the destination P2 is included in the wireless section c5.

In S1, a client apparatus 20 transmits a flight request including flight conditions of the aerial vehicle 4 to the controller 1a.

In S2, the controller is selects, as flight wireless sections, the wireless sections c1, c2, c3, c4, and c5 where wireless communication is connectable from the departure place P1 to the destination P2 from the wireless sections c1, . . . , and c6.

In S3, based on the flight conditions, the controller is reserves, with wireless base stations bs1, bs2, bs3, bs4, and bs5 located in the flight wireless sections c1, c2, c3, c4, and c5, communication bands for wirelessly communicating with the aerial vehicle 4 and performs flight control on the aerial vehicle 4.

As described above, the control apparatus 1 selects, in the flight range of the aerial vehicle 4, flight wireless sections where wireless communication is connectable and reserves, with wireless base stations located in the selected flight wireless sections, communication bands used for wireless communication with the aerial vehicle 4. This allows the control apparatus 1 to pre-ensure, with the wireless base stations, communication bands for wide-range flight of the aerial vehicle 4, thus making it possible to ensure safety of the aerial vehicle 4.

### Second Embodiment

A second embodiment will be described next. In the second embodiment, flight control is performed on a drone, which is one example of the aerial vehicle 4. Although the aerial vehicle 4 is described below as being a drone, the technology of the present disclosure may be applied to an unmanned aerial vehicle other than a drone. Hereinafter, wireless sections are referred to as “cells”, and wireless base stations are referred to as “base stations”.

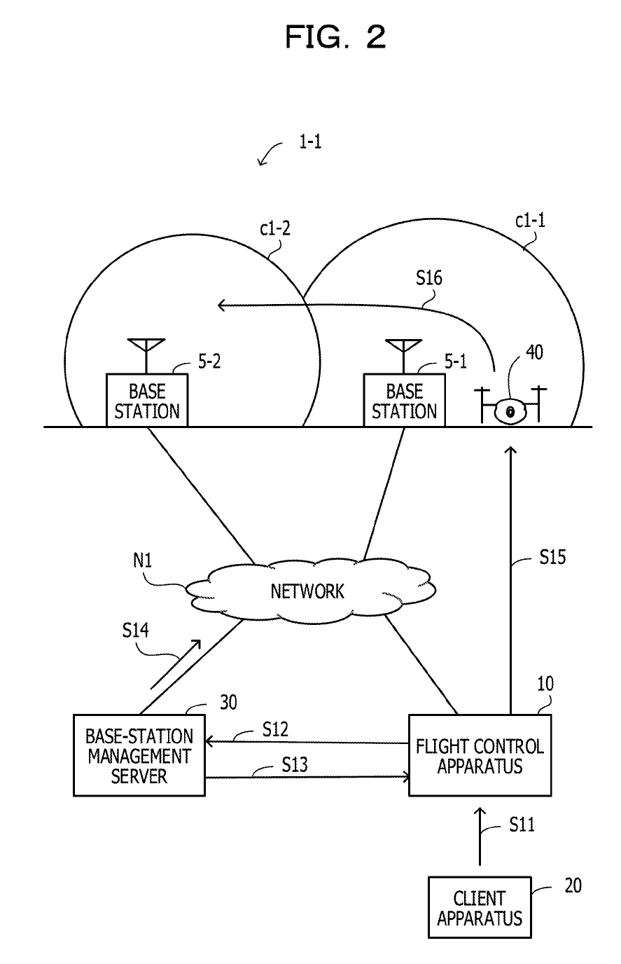

First, a description will be given of a system configuration. FIG. 2 is a diagram illustrating an example of the configuration of a flight management system. A flight management system 1-1 includes a flight control apparatus 10, a client apparatus 20, a base-station management server 30, a drone 40, a network N1, and base stations 5-1 and 5-2. The flight control apparatus 10, the base-station management server 30, and the base stations 5-1 and 5-2 connect to the network N1.

The client apparatus 20 issues a request for flight of the drone 40 to the flight control apparatus 10. The client apparatus 20 is, for example, an apparatus that is operated by a business entity, such as a drone-flight management company, or a client thereof.

The flight control apparatus 10 sets and manages a flight plan for the drone 40. The base-station management server 30 manages the base stations 5-1 and 5-2 that are located along a flight route of the drone 40.

In S11, the client apparatus 20 transmits the flight request of the drone 40 to the flight control apparatus 10. The flight request includes flight conditions used for the flight of the drone 40.

In S12, based on the received flight conditions, the flight control apparatus 10 determines the flight plan. Based on the flight plan, the flight control apparatus 10 detects the base stations 5-1 and 5-2 along the flight route of the drone 40, calculates reservation times of communication bands of the base stations 5-1 and 5-2, and transmits a reservation request to the base-station management server 30.

In S13, upon approving the reservation times of the communication bands in response to the reservation request, the base-station management server 30 transmits information indicating that the reservation times are approved to the flight control apparatus 10.

In S14, the base-station management server 30 reserves, with the base stations 5-1 and 5-2, the communication bands for the approved reservation times.

In S15, the flight control apparatus 10 permits the flight of the drone 40 and starts flight control.

In S16, the drone 40 flies the flight route specified by the flight plan, while performing wireless communication with the base stations 5-1 and 5-2 based on the reserved communication bands. In the example illustrated in FIG. 2, the drone 40 takes off from a cell c1-1 in which the base station 5-1 is provided and lands in a cell c1-2 in which the base station 5-2 is provided.

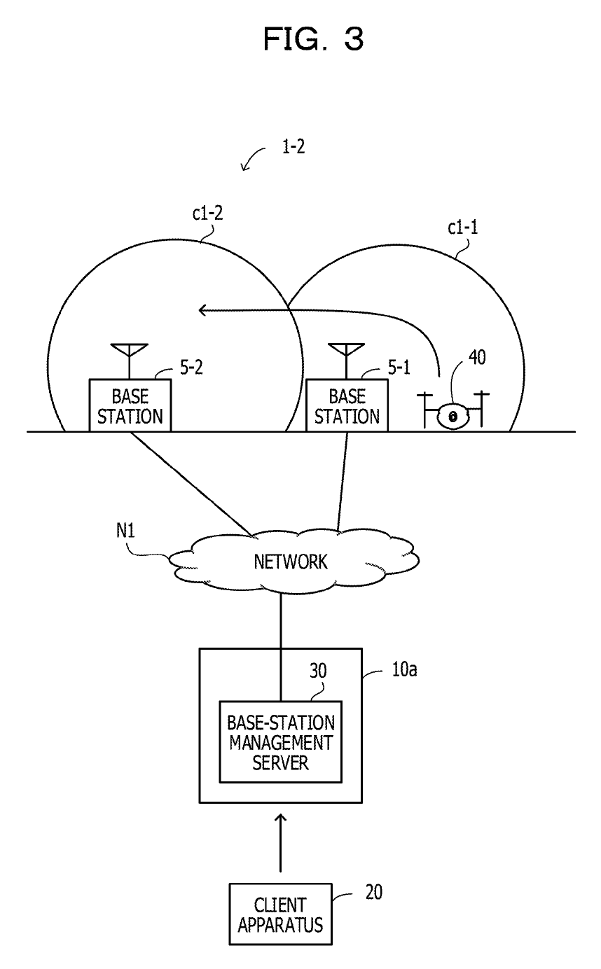

FIG. 3 is a diagram illustrating an example of the configuration of the flight management system. A flight management system 1-2 includes a flight control apparatus 10a, a client apparatus 20, a drone 40, a network N1, and base stations 5-1 and 5-2. The flight control apparatus 10a includes a base-station management server 30. The flight control apparatus 10a and the base stations 5-1 and 5-2 are connected to the network N1.

Although, in the flight management system 1-1 illustrated in FIG. 2, the flight control apparatus 10 and the base-station management server 30 are separated from each other and perform communication through the network N1, the flight control apparatus 10a in the flight management system 1-2 includes the functions of the base-station management server 30. In this manner, the flight control apparatus and the base-station management server may be integrally configured.

<Hardware of Flight Control Apparatus>

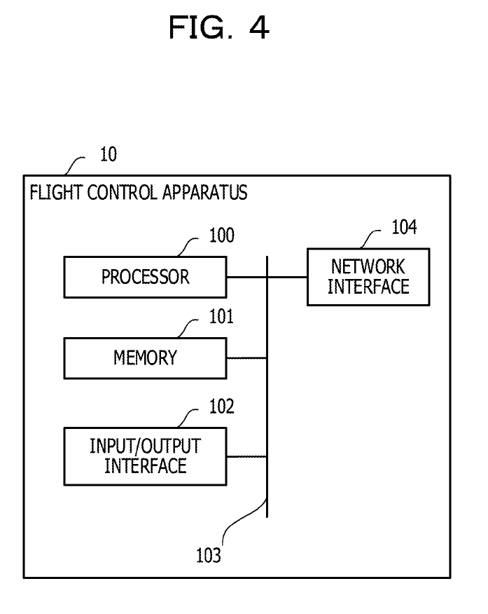

FIG. 4 is a diagram illustrating an example of the hardware configuration of the flight control apparatus. A processor 100 controls the entire flight control apparatus 10. That is, the processor 100 functions as a controller of the flight control apparatus 10.

A memory 101 and a plurality of pieces of peripheral equipment are connected to the processor 100 through a bus 103. The processor 100 may be a multiprocessor. The processor 100 is, for example, a central processing unit (CPU), a micro processing unit (MPU), a digital signal processor (DSP), an application-specific integrated circuit (ASIC), or a programmable logic device (PLD). The processor 100 may be a combination of two or more of a CPU, an MPU, a DSP, an ASIC, and a PLD.

The memory 101 is used as a primary storage device of the flight control apparatus 10. At least one of an operating system (OS) program and application programs, which are executed by the processor 100, is temporarily stored in the memory 101. Various types of data used for processing performed by the processor 100 are stored in the memory 101.

The memory 101 is also used as an auxiliary storage device of the flight control apparatus 10, and an OS program, application programs, and various types of data are stored therein. The memory 101 may include a semiconductor storage device, such as a flash memory or a solid-state drive (SSD), or a magnetic recording medium, such as a hard disk drive (HDD), as an auxiliary storage device.

The peripheral equipment connected to the bus 103 includes an input/output interface 102 and a network interface 104. A monitor (for example, a light-emitting diode (LED) or a liquid-crystal display (LCD)) is connected to the input/output interface 102 and functions as a display device for displaying the state of the flight control apparatus 10 in accordance with an instruction from the processor 100.

Information input devices, such as a keyboard and a mouse, may be connected to the input/output interface 102. The input/output interface 102 performs interface control with the client apparatus 20 and transmits signals, sent from the information input devices, to the processor 100.

In addition, the input/output interface 102 also serves as a communication interface for connection with peripheral equipment. For example, an optical drive device that reads data recorded on an optical disk by using laser light or the like may be connected to the input/output interface 102.

The optical disk is a portable recording medium on which data is recorded so as to be readable via light reflection. Examples of the optical disk include a digital versatile disc (DVD), a digital versatile disc random-access memory (DVD-RAM), a compact disc read-only memory (CD-ROM), and a compact disc readable/writable (CD-R/RW).

A memory device and a memory reader/writer may be connected to the input/output interface 102. The memory device is a recording medium having a function of communicating with the input/output interface 102. The memory reader/writer is a device for writing data to a memory card or reading data from a memory card. The memory card is a card-type recording medium.

The network interface 104 performs interface control with the network N1 and may be implemented by, for example, a network interface card (NIC), a wireless LAN card, or the like. Data received by the network interface 104 is output to the memory 101 and the processor 100.

With a hardware configuration as described above, it is possible to realize processing functions of the flight control apparatus 10. For example, in the flight control apparatus 10, the processor 100 can perform the flight management and control in the present disclosure by executing a predetermined program.

In the flight control apparatus 10, for example, the processing functions in the present disclosure can be realized by executing a program recorded in a computer-readable recording medium. A program in which content of processing to be executed by the flight control apparatus 10 may be recorded in/on various recording media.

For example, the program to be executed by the flight control apparatus 10 may be stored in an auxiliary storage device. The processor 100 loads at least part of the program in the auxiliary storage device into the primary storage device and executes the program.

The program may also be recorded in/on portable recording media, such as an optical disk, a memory device, and a memory card. The program stored in/on a portable recording medium is executable after being installed to, for example, an auxiliary storage device, under the control of the processor 100. The processor 100 may also execute the program by directly reading the program from a portable recording medium.

Although the configuration in FIG. 4 has been described above as being implemented by the hardware of the flight control apparatus 10, the base-station management server 30 may also be implemented by similar hardware.

<Functional Blocks>

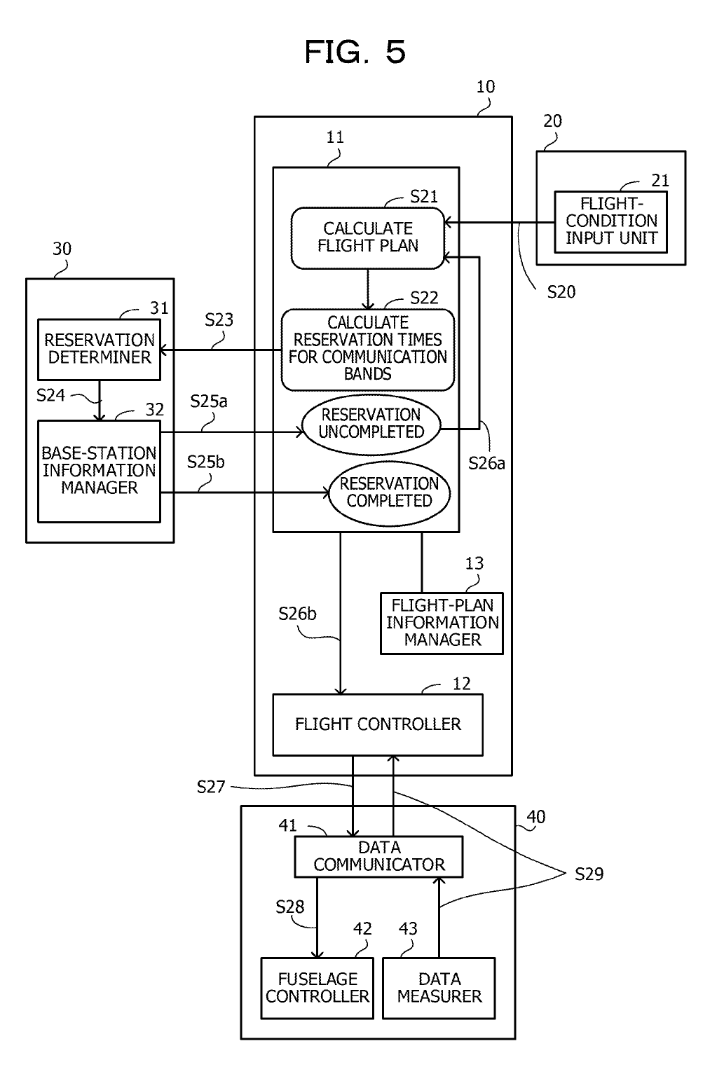

FIG. 5 is a diagram illustrating an example of functional blocks. The flight control apparatus 10 includes a flight plan manager 11, a flight controller 12, and a flight-plan information manager 13. The client apparatus 20 includes a flight-condition input unit 21. The base-station management server 30 includes a reservation determiner 31 and a base-station information manager 32. The drone 40 includes a data communicator 41, a fuselage controller 42, and a data measurer 43.

In S20, the flight-condition input unit 21 inputs flight conditions used for drone flight to the flight plan manager 11 in the flight control apparatus 10.

Information of the flight conditions includes, for example, a destination of the drone 40, an arrival time at the destination, information indicating whether or not a predetermined communication service is executed between a base station and the drone 40 (hereinafter referred to as the “presence/absence of a service”). For example, a service for streaming video captured during flight of the drone 40 corresponds to the communication service.

In S21, based on the input flight conditions, the flight plan manager 11 calculates a flight plan, including a flight route, a flight start time, a flight speed, and so on, of the drone 40.

In S22, based on the flight plan, the flight plan manager 11 selects cells along the flight route of the drone 40. When the drone 40 is to fly the selected cells, the flight plan manager 11 calculates reservation times of communication bands of base stations provided in the cells when the communication bands are to be used.

In S23, the flight plan manager 11 transmits the reservation times of the communication bands to the reservation determiner 31 in the base-station management server 30.

In S24, the reservation determiner 31 refers to table information (described below) managed by the base-station information manager 32 to determine whether or not the communication bands of the corresponding base stations are available in the received reservation times.

In S25a, upon determining that the communication bands of the corresponding base stations are not available, the reservation determiner 31 transmits a result indicating the reservation is uncompleted to the flight plan manager 11.

In S25b, upon determining that the communication bands of the corresponding base stations are available, the reservation determiner 31 reserves the communication bands of the corresponding base stations and transmits a result indicating that the reservation is completed to the flight plan manager 11.

In S26a, when the flight plan manager 11 receives the result indicating the reservation is uncompleted, the process returns to S21 in which the flight plan manager 11 re-calculates the flight plan.

In S26b, upon receiving the result indicating that the reservation is completed, the flight plan manager 11 registers the flight route and transmits flight plan information (such as the flight route, the flight start time, and the flight speed) to the flight controller 12. The flight plan calculated by the flight plan manager 11 is stored in the flight-plan information manager 13 and is managed.

In S27, the flight controller 12 transmits the determined flight plan information to the data communicator 41 in the drone 40 via a base station in a cell along the flight route.

In S28, the fuselage controller 42 in the drone 40 controls the flight of the drone 40, based on the flight plan information received by the data communicator 41. Wireless communication is performed between the data communicator 41 and the flight controller 12 via the base station in the cell along the flight route, and the drone 40 performs wide-range flight over the determined flight route.

In S29, the drone 40 that has started flying measures data (such as altitude data, position data, and video-monitoring data) at regular intervals by using the data measurer 43. The data communicator 41 performs wireless communication with the base station in the cell along the flight route to transmit the measured data to the flight controller 12. The data measurement is repeatedly performed until the drone 40 arrives at the destination, and is finished when the drone 40 arrives at the destination.

The flight plan manager 11, the flight controller 12, and the reservation determiner 31, which are described above, are realized by the processor 100 illustrated in FIG. 4. The data storage functions of the flight-plan information manager 13 and the base-station information manager 32 are realized by the memory 101 illustrated in FIG. 4. The individual functional units may also be configured by hardware circuits using logic circuits and so on. The control apparatus 1 illustrated in FIG. 1 has the functions of both the flight control apparatus 10 and the base-station management server 30.

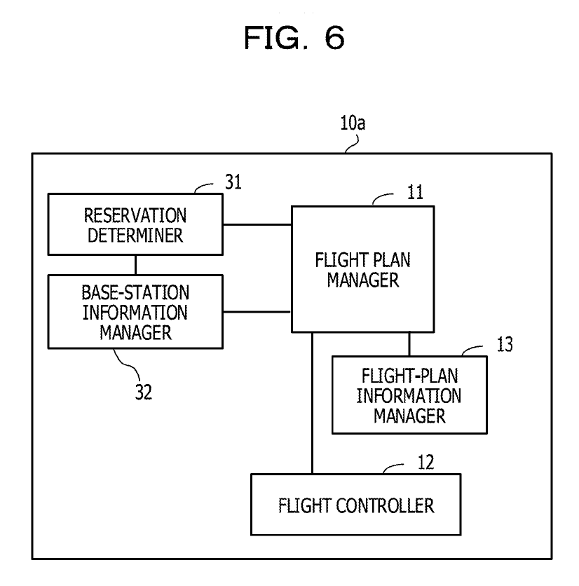

FIG. 6 is a diagram illustrating an example of the functional blocks in the flight control apparatus. The flight control apparatus 10a includes the flight plan manager 11, the flight controller 12, the flight-plan information manager 13, the reservation determiner 31, and the base-station information manager 32.

In the example illustrated in FIG. 5, the flight control apparatus 10 and the base-station management server 30 are separated from each other. In the example illustrated in FIG. 6, however, the flight control apparatus 10a includes the functional blocks of the base-station management server 30. In this manner, the flight control apparatus may have a configuration including the functional blocks of the base-station management server 30.

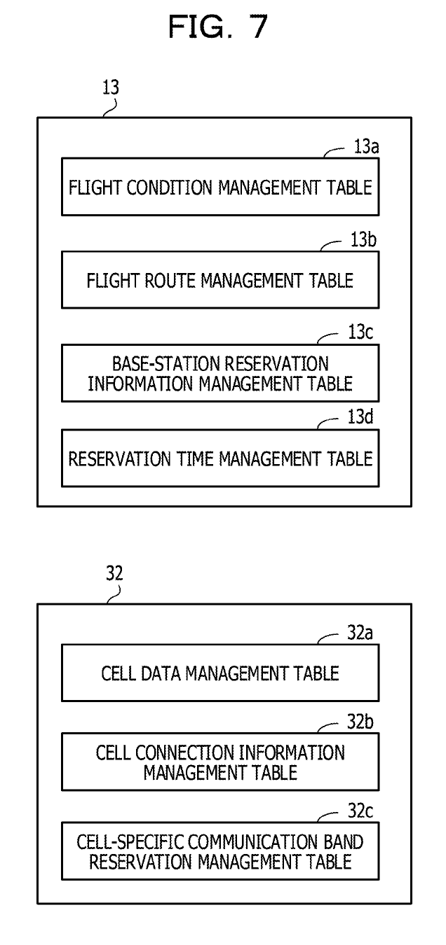

FIG. 7 illustrates examples of tables stored in the flight-plan information manager and the base-station information manager. The flight-plan information manager 13 includes a flight condition management table 13a, a flight route management table 13b, a base-station reservation information management table 13c, and a reservation time management table 13d. The base-station information manager 32 includes a cell data management table 32a, a cell connection information management table 32b, and a cell-specific communication band reservation management table 32c. Details of the individual tables are described later.

<Operation Flowchart of Flight Management System>

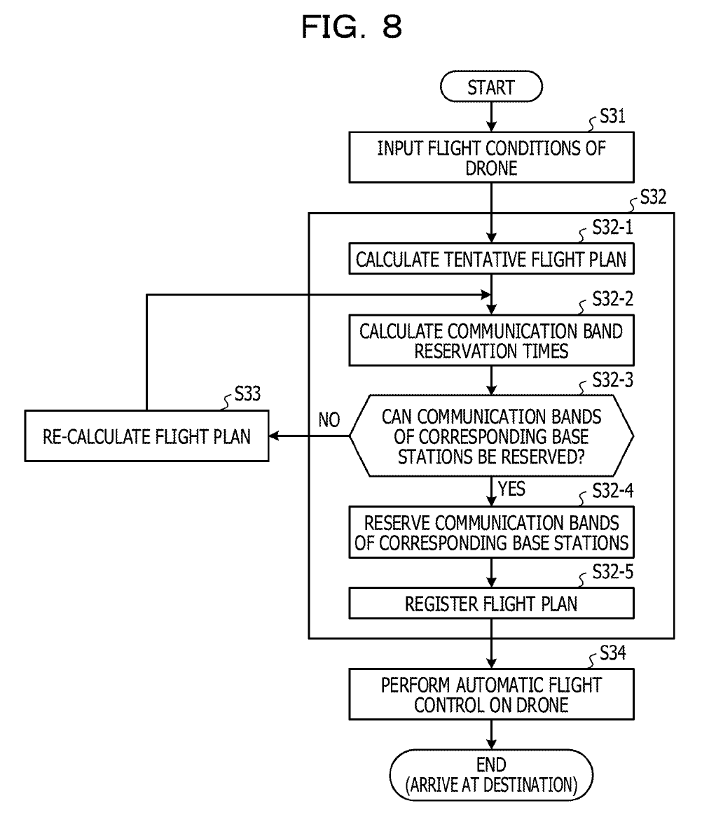

FIG. 8 illustrates an example of an operation flowchart of the flight management system.

In S31, the client apparatus 20 inputs flight conditions of the drone 40 to the flight control apparatus 10.

In S32, the flight control apparatus 10 performs calculation processing for a flight plan, and the base-station management server 30 makes a reservation determination of communication bands and reserves the communication bands. This processing includes S32-1, . . . , and S32-5.

In S32-1, based on the input flight conditions, the flight control apparatus 10 calculates a tentative flight plan.

In S32-2, the flight control apparatus 10 calculates communication band reservation times.

In S32-3, the base-station management server 30 determines whether or not communication bands of corresponding base stations can be reserved for the calculated reservation times. When the communication bands are not reservable, the process proceeds to S33. When the communication bands are reservable, the process proceeds to S32-4.

In S32-4, the base-station management server 30 reserves the communication bands of the corresponding base stations.

In S32-5, the flight control apparatus 10 registers the flight plan.

In S33, the flight control apparatus 10 re-calculates the flight plan. The process then returns to S32-2.

In S34, the drone 40 automatically flies under flight control based on the flight plan determined by the flight control apparatus 10.

<Flight Conditions of Drone>

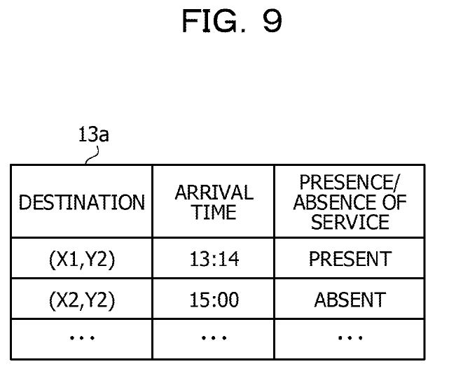

Next, a description will be given of a specific example of the flight conditions that are input, the flight conditions being described in S31 in FIG. 8. FIG. 9 illustrates an example of the flight condition management table. Upon receiving the input flight conditions from the client apparatus 20, the flight plan manager 11 registers the flight conditions in the flight condition management table 13a.

The flight condition management table 13a has “destination”, “arrival time”, and “presence/absence of service (service information)” as items, and flight conditions corresponding to the items are registered in the flight condition management table 13a. For the “destination”, for example, latitude and longitude information is set as destination information of the drone 40. For the “arrival time”, a time at which the drone 40 arrives at the corresponding destination is set.

For the “presence/absence of service”, whether or not a service is to be executed during flight of the drone 40 is set. For example, when the drone 40 is to execute video streaming, “present” is set, and when the drone 40 is not to execute video streaming, “absent” is set.

<Calculation Processing for Drone Flight Plan>

Next, the process illustrated in S32 in FIG. 8 will be described in detail.

(Identifying Cell of Departure Place and Cell of Destination)

Based on the destination information input as a flight condition, the flight plan manager 11 queries the base-station information manager 32 in the base-station management server 30 about to which base station cell the destination belongs. The base-station information manager 32 identifies a cell to which the destination belongs by referring to the contents registered in the cell data management table and transmits the identified cell to the flight plan manager 11.

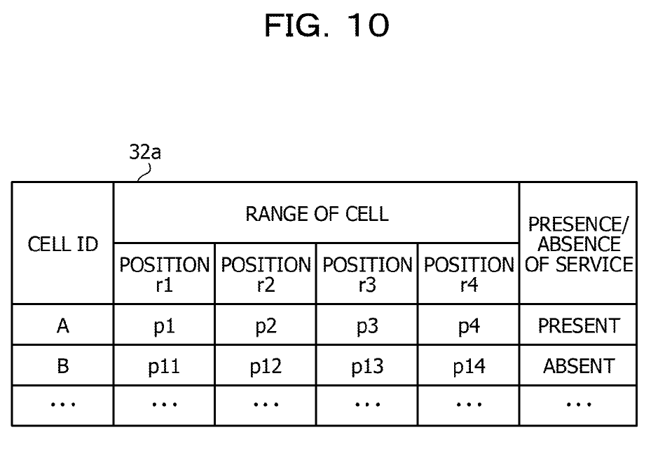

FIG. 10 illustrates an example of the cell data management table. The cell data management table 32a has “cell ID”, “range of cell”, and “presence/absence of service” as items.

The range of one cell is defined as a range including four points, that is, positions r1, . . . , and r4. Each of the positions r1, . . . , and r4 is indicated by, for example, longitude and latitude information.

In the example in FIG. 10, a cell with cell ID=A includes four points (r1, r2, r3, r4)=(p1, p2, p3, p4) and is registered as a cell in which a service is present. When a destination input as a flight condition is included in a range including the four points (p1, p2, p3, p4), the base-station information manager 32 determines that the destination is included in the cell with cell ID=A. Then, the base-station information manager 32 transmits, to the flight plan manager 11 as cell information for the destination, cell ID=A, and the coordinates of a base station having the cell with cell ID=A as a wireless range.

Upon obtaining the cell information to which the destination belongs, the flight plan manager 11 also queries the base-station information manager 32 about cell information for the departure place of the drone 40 in the same manner as described above, to thereby obtain the cell information to which the departure place belongs. The departure place of the drone 40 is not included in the flight conditions, since a particular drone takeoff place exists at the departure place.

(Cell Connections)

Upon obtaining the cell information for the departure place and the cell information for the destination, the flight plan manager 11 queries the base-station information manager 32 about cell connections from the departure place to the destination (that is, inter-cell connections via which handover is possible). Upon being queried, the base-station information manager 32 transmits, to the flight plan manager 11, cell connection information indicating the cell connections from the departure place to the destination.

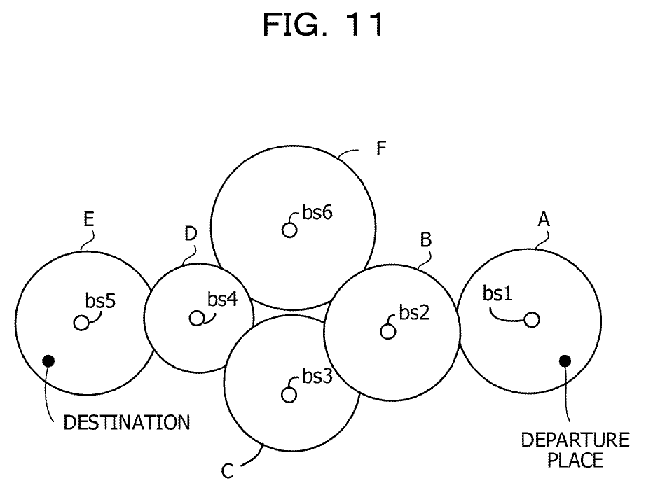

FIG. 11 is a diagram illustrating an example of cell connections. The departure place is included in a cell with cell ID=A (hereinafter, a cell with cell ID=x is also referred to as a “cell x”), the destination exists in a cell E, and cells B, C, D, and F exist between the cell A and the cell E.

The cell A is a wireless area of a base station bs1, the cell B is a wireless area of a base station bs2, and the cell C is a wireless area of a base station bs3. The cell D is a wireless area of a base station bs4, the cell E is a wireless area of a base station bs5, and the cell F is a wireless area of a base station bs6.

The relationship of cell connections is that the cell A is connected to the cell B, the cell B is connected to the cells A, C, and F, and the cell C is connected to the cells B and D. The cell D is connected to the cells C, E, and F, the cell E is connected to the cell D, and the cell F is connected to the cells B and D.

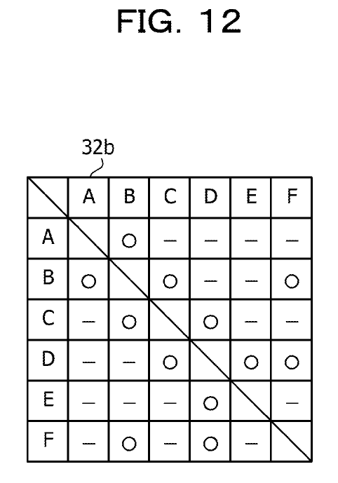

FIG. 12 is a table illustrating an example of management of the cell connection information. The base-station information manager 32 has a cell connection information management table 32b and manages the connection relationship of the cells illustrated in FIG. 11 as the cell connection information.

In the cell connection information management table 32b, the rows and columns indicate cell IDs=A, . . . , and F, and “0” is registered for each combination of connected cells (“-” is indicated for each combination of unconnected cells). For example, when a combination (row, column) is (A, B), (A, B)=O is registered to indicate that the cells A and B are connected to each other (that is, handover is possible between the cells A and B).

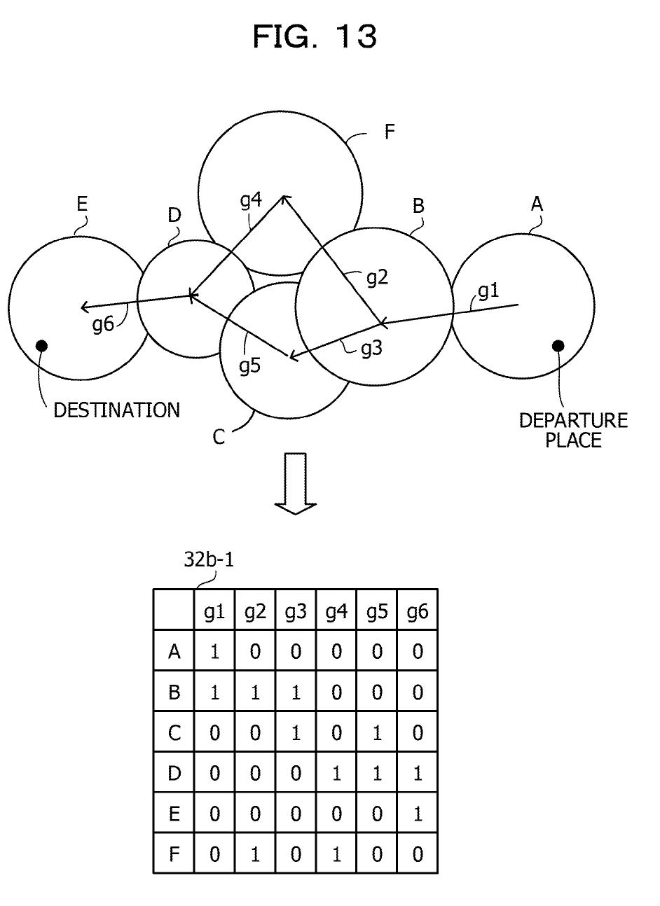

FIG. 13 illustrates an example of management of the cell connection information. Routes having connections between the cells are indicated by directed graphs, and the cell connection relationship may be managed with directed graph numbers given to the directed graphs.

A directed graph g1 indicates a route from the cell A to the cell B, a directed graph g2 indicates a route from the cell B to the cell F, and a directed graph g3 indicates a route from the cell B to the cell C.

A directed graph g4 indicates a route from the cell F to the cell D, a directed graph g5 indicates a route from the cell C to the cell D, and a directed graph g6 indicates a route from the cell D to the cell E.

In a cell connection information management table 32b-1, the rows indicate cell IDs=A, . . . , and F, the columns indicate the directed graphs g1, . . . , and g6, “1” is registered for each combination of connected cells, and “0” is registered for each combination of unconnected cells.

For example, for a combination (row, column) is (A, g1), (A, g1)=1 is indicated. Thus, there is a directed graph g1 having its start point in the cell A, and the directed graph g1 indicates a route having a connection from the cell A to the cell B, thus indicating that the cells A and B are connected to each other.

(Registration of Tentative Flight Route)

The flight plan manager 11 obtains the cell connection information between a departure place and a destination, the cell connection information being transmitted from the base-station information manager 32. Upon recognizing that the number of cell connections is one based on the obtained cell connection information, the flight plan manager 11 sets the cell connection as a tentative flight route.

Upon recognizing that the number of cell connections between the departure place and the destination is two or more based on the obtained cell connection information, the flight plan manager 11 detects a shortest route when the distance between the cells is cost (for example, a Bellman-Ford algorithm or a Dijkstra's algorithm is used as a method for detecting the shortest route).

When there is no cell connection between the departure place and the destination, or when a shortest route is not successfully detected, the flight plan manager 11 issues a request for re-inputting a new flight condition to the client apparatus 20.

Now, it is assumed that the shortest route has been detected. The flight plan manager 11 generates a tentative flight route, based on the shortest route, and registers the tentative flight route in the flight route management table 13b.

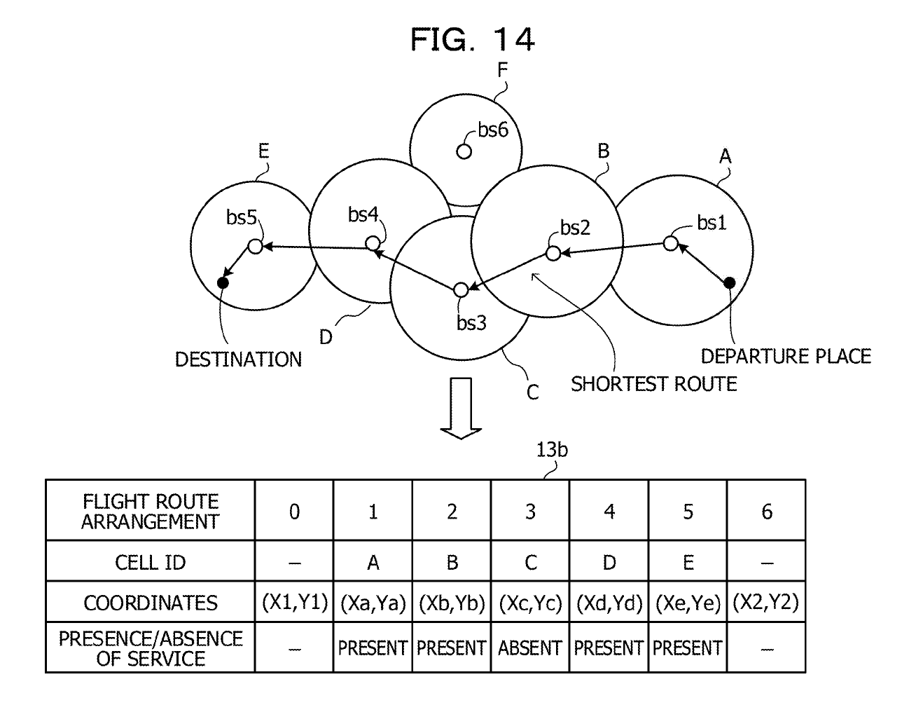

FIG. 14 illustrates an example of the flight route management table. It is assumed that the flight plan manager 11 has detected a flight route in the order the cell A (the base station bs1), the cell B (the base station bs2), the cell C (the base station bs3), the cell D (the base station bs4), and the cell E (the base station bs5) as the shortest route.

The flight route management table 13b is managed as a sequential arrangement of cells along a route the drone 40 flies. The flight route management table 13b has “cell ID”, “coordinates (the position of a base station)”, and “presence/absence of service” as items.

A registration example of the flight route management table 13b based on the shortest route illustrated in FIG. 14 will be described below. In the cells A, B, D, and E, a video streaming service is available, and in the cell C, the service is not available.

For a flight route arrangement number=0, coordinates (X1, Y1) of the departure place are registered. For the flight route arrangement number=1, the cell ID=A, the coordinates of the base station bs1=(Xa, Ya), and a service being present are registered. For the flight route arrangement number=2, the cell ID=B, the coordinates of the base station bs2=(Xb, Yb), and the service being present are registered.

For the flight route arrangement number=3, the cell ID=C, the coordinates of the base station bs3=(Xc, Yc), and the service being absent are registered. For the flight route arrangement number=4, the cell ID=D, the coordinates of the base station bs4=(Xd, Yd), and the service being present are registered.

For the flight route arrangement number=5, the cell ID=E, the coordinates of the base station bs5=(Xe, Ye), and the service being present are registered. For the flight route arrangement number=6, the coordinates of the destination=(X2, Y2) are registered.

<Selection of Base Stations Based on Presence/Absence of Service>

Upon registering the tentative flight route, the flight plan manager 11 performs processing for selecting base stations, based on the presence/absence of the service. In this case, the flight plan manager 11 determines the presence/absence of the service for a drone flight, by using the service information included in the flight conditions input from the client apparatus 20.

When the service being absent is set in the service information in the flight conditions, the flight plan manager 11 advances to processing for setting a flight speed of the drone 40. On the other hand, when the service being present is set in the service information in the flight conditions, the flight plan manager 11 refers to the flight route management table 13b to determine whether or not the sequential cells that form the tentative flight route includes a cell in which the service is absent.

When all of the sequential cells that form the tentative flight route are cells in which the service is present and do not include a cell in which the service is absent, the flight plan manager 11 advances to processing for setting the flight speed. When the sequential cells that form the tentative flight route include a cell in which the service is absent, the flight plan manager 11 re-detects a shortest route. In this case, the flight plan manager 11 disables selection of the cell in which the service is absent, to thereby ensure that the cell is not selected during the re-detection of the shortest route.

In this case, when it is assumed that the service information in the flight conditions indicates that the service is present, the cell C is a cell in which the service is absent, in the example illustrated in FIG. 14. In this case, the flight plan manager 11 disables selection of the cell C and re-detects the shortest route.

Since the flight plan manager 11 performs such base station selection processing, base stations that can provide a service are efficiently selected, thus making it possible to determine a flight route along which a service, such as video streaming, is executed.

<Generation of Base-Station Reservation Information Management Table>

Upon determining the shortest route, the flight plan manager 11 sets a flight speed V (an initial flight speed) of the drone 40 and determines a time taken to arrive at the destination along the determined shortest route. The flight plan manager 11 then generates the base-station reservation information management table 13c.

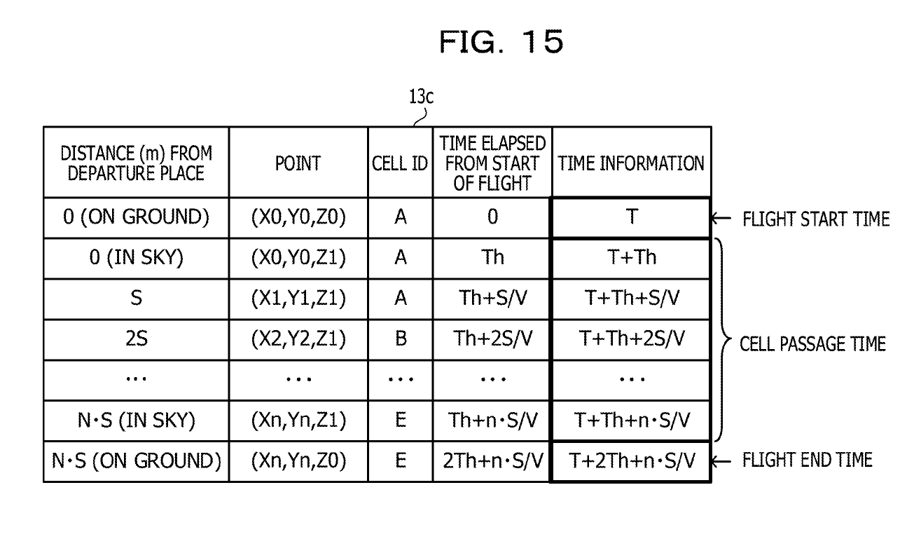

FIG. 15 is a table for describing generation of the base-station reservation information management table. The base-station reservation information management table 13c has “distance (m) from departure place”, “point”, “cell ID”, “time elapsed from start of flight”, and “time information” as items.

The “distance from departure place” represents a distance from a departure place when a flight route is sectioned into a plurality of sections, and one section is denoted by S(m).

The “point” is indicated by coordinates of an estimated point where the drone 40 flies for each S(m). Since the speed of the drone 40 is denoted by V, the coordinates of the site for every S meters along the flight route can be estimated. The values of the X coordinates in FIG. 15 indicate latitudes, the values of the Y coordinates indicate longitudes, and the values of the Z coordinates indicate altitudes (every site in the sky is indicated by Z1, assuming that the drone 40 is flies at a certain altitude).

The “cell ID” represents an ID of a cell including the coordinates of the corresponding site. The “time elapsed from start of flight” is determined, for example, according to equation (1).

“Time elapsed from start of flight”=Th+(n·S/V)(1)

In equation (1), Th indicates a time taken for the drone 40 to ascend or descend until it reaches a certain altitude, n·S indicates a distance (n=0, 1, 2 . . . ) from the departure place, and V indicates a flight speed. It is assumed that Th is measured in advance and is known.

Based on equation (1), the flight plan manager 11 may calculate a time taken for the drone 40 to arrive at the destination from when it starts flying (the time indicated in the last row of the “time elapsed from start of flight” in the base-station reservation information management table 13c).

The “time information” includes “flight start time (takeoff time)”, “cell passage time”, and “flight end time (landing time)”. The “flight start time” is a time at which the drone 40 starts flying from the departure place. Since the flight plan manager 11 determines the time taken to arrive at the destination (that is, the time indicated in the last row of the “time elapsed from start of flight” in the base-station reservation information management table 13c), the flight plan manager 11 determines, as a flight start time T, a time obtained by subtracting the time taken to arrive at the destination from the arrival time in the flight conditions.

The “cell passage time” is a time point obtained by adding the “time elapsed from start of flight” to the flight start time T. The “flight end time” is a time point when the drone 40 lands at the destination after descending to the ground.

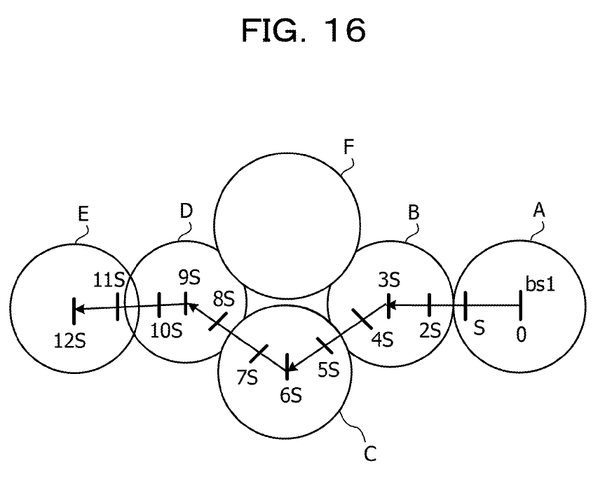

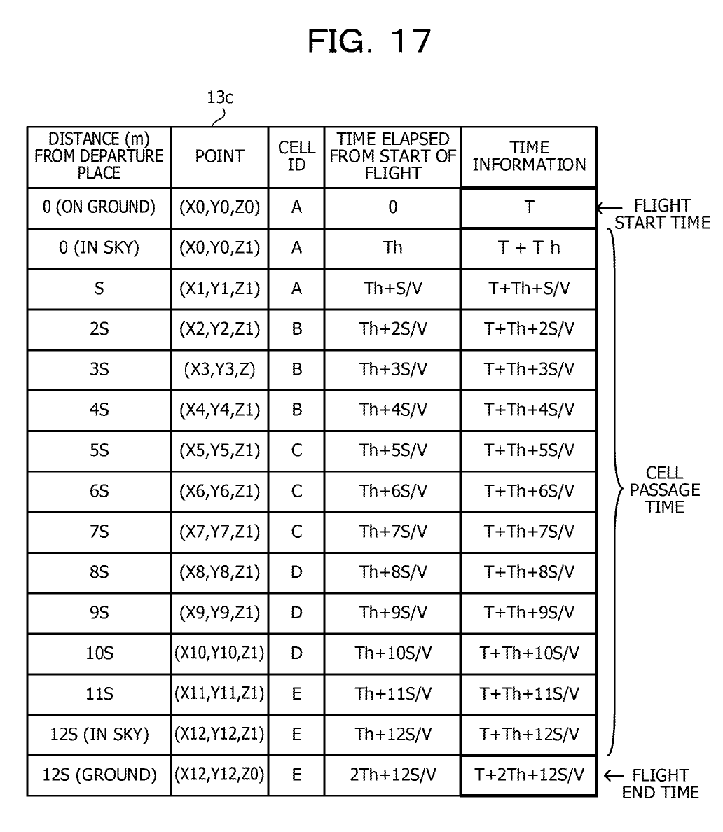

FIG. 16 is a diagram illustrating an example in which distances from the departure place are set on a flight route. FIG. 16 illustrates a state in which the flight route is divided into 12 reaching points. The distance of one section is S. FIG. 17 illustrates a registration example of the base-station reservation information management table.

The base-station reservation information management table 13c illustrated in FIG. 17 illustrates a registration example of “site”, “cell ID”, “time elapsed from start of flight”, and “time information” corresponding to the “distance from departure place” along the flight route illustrated in FIG. 16.

<Reservation Times of Communication Bands>

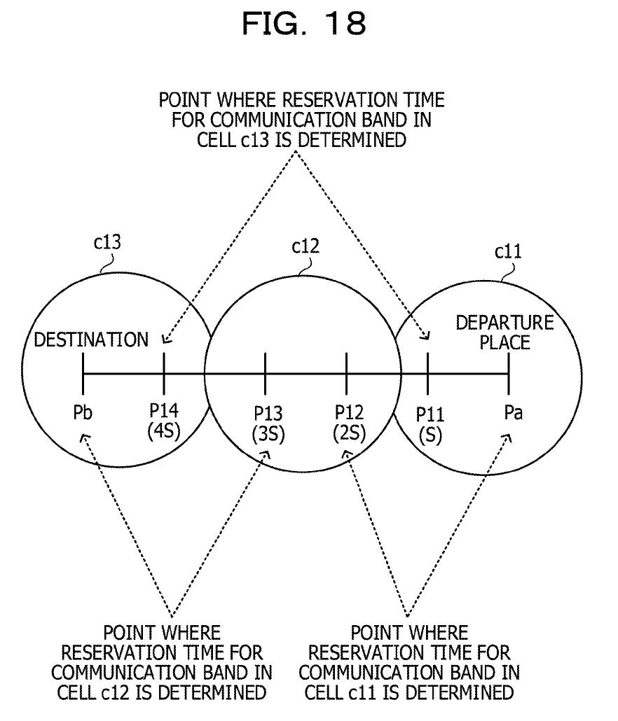

After generating the base-station reservation information management table 13c, the flight plan manager 11 sets reservation times of communication band in respective cells. FIG. 18 is a diagram illustrating an example of setting of reservation times of communication bands. A departure place Pa is included in a cell c11, a destination Pb is included in a cell c13, and this flight route passes through the cells c11, c12, and c13. For this flight route, reaching points P11 (S), P12 (2S), P13 (3S), and P14 (4S) are set. No reaching point is set in overlapping areas of the cells.

With respect to a communication band reservation time for the cell c11, the flight plan manager 11 uses a flight start time at which the drone 40 takes off from the departure place Pa as a communication band reservation start time for the cell c11. (a first flight wireless section).

The flight plan manager 11 uses a reaching time (a first reaching time) at the reaching point P12 (a first flight reaching point), which is a first reaching point that the drone 40 reaches in the cell c12 (a second flight wireless section), as a communication band reservation end time for the cell c11.

With respect to a communication band reservation time for the cell c12, the flight plan manager 11 uses a reaching time (a second reaching time) at the reaching point P11 (a second flight reaching point), which is a last reaching point that the drone 40 reaches in the cell c11, as a communication band reservation start time for the cell c12.

The flight plan manager 11 uses a reaching time (a third reaching time) at the reaching point P14 (a third flight reaching point), which is a first reaching point that the drone 40 reaches in the cell c13 (a third flight wireless section), as a communication band reservation end time for the cell c12.

With respect to a communication band reservation time for the cell c13, the flight plan manager 11 uses a reaching time (a fourth reaching time) at the reaching point P13 (a fourth flight reaching point), which is a last reaching point that the drone 40 reaches in the cell c12, as a communication band reservation start time for the cell c13. The flight plan manager 11 uses a flight end time when the drone 40 lands at the destination Pb as a communication band reservation end time for the cell c13.

<Generation of Reservation Time Management Table>

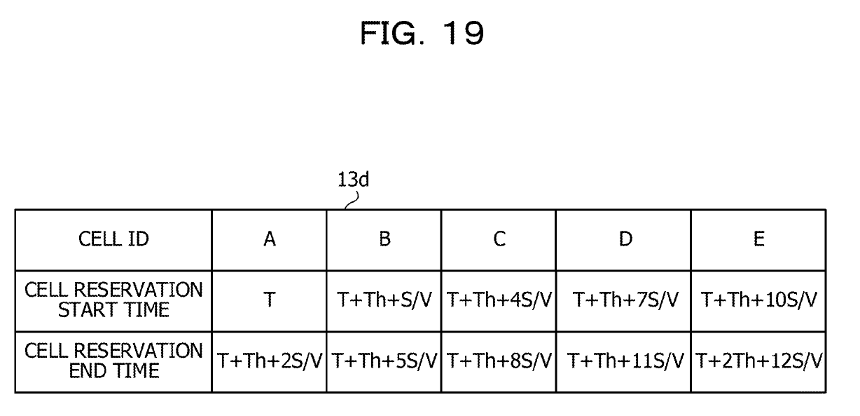

FIG. 19 illustrates an example of the reservation time management table. After generating the base-station reservation information management table 13c, the flight plan manager 11 generates the reservation time management table 13d. The reservation time management table 13d has “cell ID”, “cell reservation start time”, and “cell reservation end time”.

The cell reservation start time (the communication band reservation start time) is a time for starting reservation of a band for drone flight with the base station in a cell when the drone 40 that is flying enters the cell.

The cell reservation end time (the communication band reservation end time) is a time for ending reservation of a band for drone flight with the base station in a cell when the drone 40 that is flying exits the cell.

The following description will be given of the contents registered in the reservation time management table 13d generated based on the contents registered in the base-station reservation information management table 13c illustrated in FIG. 17.

(Communication Band Reservation Time for Cell A)

The drone 40 starts flying from the cell A, and the first flight range of the drone 40 moves from the cell A to the cell B. Accordingly, when a communication band in the cell A from the flight start time until a first cell passage time in the cell B is reserved, it is possible to ensure the communication band in the cell A.

Hence, the flight plan manager 11 registers the flight start time T as a reservation start time for the cell A and registers a first cell passage time (T+Th+2 S/V) in the cell B as a reservation end time for the cell A.

(Communication Band Reservation Time for Cell B)

The next flight range of the drone 40 moves from the cell A to the cell B and then moves from the cell B to the cell C. Accordingly, when a communication band in the cell B from a last cell passage time in the cell A until a first cell passage time in the cell C is reserved, it is possible to ensure the communication band in the cell B.

Hence, the flight plan manager 11 registers a last cell passage time (T+Th+S/V) in the cell A as a reservation start time for the cell B and registers a first cell passage time (T+Th+5 S/V) in the cell C as a reservation end time for the cell B.

(Communication Band Reservation Time for Cell C)

The next flight range of the drone 40 moves from the cell B to the cell C and then moves from the cell C to the cell D. Accordingly, when a communication band in the cell C from a last cell passage time in the cell B until a first cell passage time in the cell D is reserved, it is possible to ensure the communication band in the cell C.

Hence, the flight plan manager 11 registers a last cell passage time (T+Th+4 S/V) in the cell B as a reservation start time for the cell C and registers a first cell passage time (T+Th+8 S/V) in the cell D as a reservation end time for the cell C.

(Communication Band Reservation Time for Cell D)

The next flight range of the drone 40 moves from the cell C to the cell D and then moves from the cell D to the cell E. Accordingly, when a communication band in the cell D from a last cell passage time in the cell C until a first cell passage time in the cell E is reserved, it is possible to ensure the communication band in the cell D.

Hence, the flight plan manager 11 registers a last cell passage time (T+Th+7 S/V) in the cell C as a reservation start time for the cell D. The flight plan manager 11 then registers a first cell passage time (T+Th+11 S/V) in the cell E as a reservation end time for the cell D.

(Communication Band Reservation Time for Cell E)

The next flight range of the drone 40 moves from the cell D to the cell E, and then the drone 40 lands at the destination in the cell E. Accordingly, when a communication band in the cell E is reserved from a last cell passage time in the cell D until the flight end time, it is possible to ensure the communication band in the cell E.

Hence, the flight plan manager 11 registers a last cell passage time (T+Th+10 S/V) in the cell D as a reservation start time for the cell E. The flight plan manager 11 then registers a flight end time (T+2Th+12 S/V) as a reservation end time for the cell E.

The flight plan manager 11 sets reservation times for communication bands, as described above. Thus, for example, when the drone 40 is flying in one cell in an ordinally manner, it is possible to inhibit being late for a reservation time of a communication band in the cell.

<Determination as to Whether or Not Communication Bands are Reservable>

Upon determining the reservation times for the communication bands in the respective cells, the flight plan manager 11 transmits the reservation times to the reservation determiner 31 in the base-station management server 30. The reservation determiner 31 refers to the cell-specific communication band reservation management table 32c to determine whether or not the communication bands can be reserved with the corresponding base stations for the reservation times determined by the flight plan manager 11.

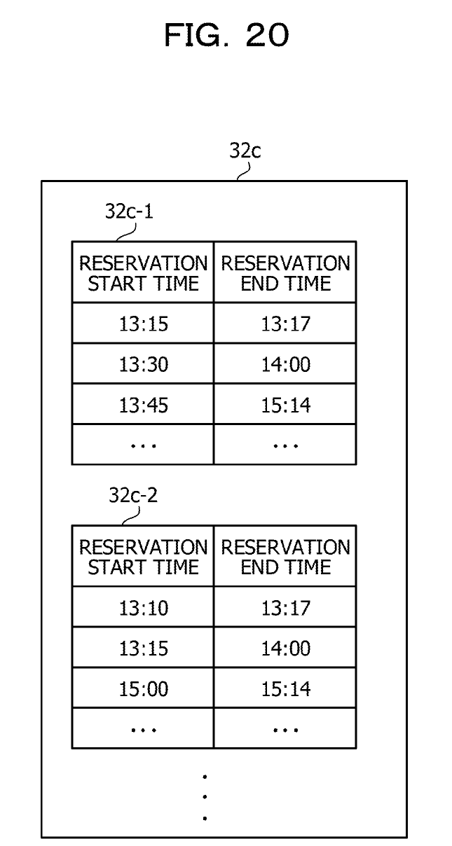

FIG. 20 illustrates an example of the cell-specific communication band reservation management table. The cell-specific communication band reservation management table 32c includes communication band reservation tables 32c-1, 32c-2 . . . for the respective cells. In the example illustrated in FIG. 20, the communication band reservation table 32c-1 is for a cell A, and the communication band reservation table 32c-2 is for a cell B.

Each communication band reservation table includes “reservation start time” and “reservation end time” as items. In each communication band reservation table, each time segment in which a communication band can be reserved is registered using a reservation start time and a reservation end time. Upon receiving a reservation time for the communication band for one cell, the reservation time being determined by the flight plan manager 11, the reservation determiner 31 refers to the communication band reservation table for the cell to determine whether or not the communication band in the cell can be reserved for the received reservation time.

An upper-limit value (an allowable value) of the number of aerial vehicles is predetermined for each cell with respect to reservation times in the cell-specific communication band reservation management table 32c. When the number of aerial vehicles that reserve the reservation times reaches the upper-limit value, reservation of the communication band is not permitted.

When it is determined in the communication band reservation determination processing in the reservation determiner 31 that the number of aerial vehicles that reserve the reservation times reaches the upper-limit value, the flight plan manager 11 determines that a flight using the current flight route (the tentative flight route) is not possible. When the reservation determiner 31 determines that the number of aerial vehicles that reserve the reservation times does not reach the upper-limit value, the flight plan manager 11 determines that a flight using the current flight route is possible.

<Flowchart of Flight Plan Calculation>

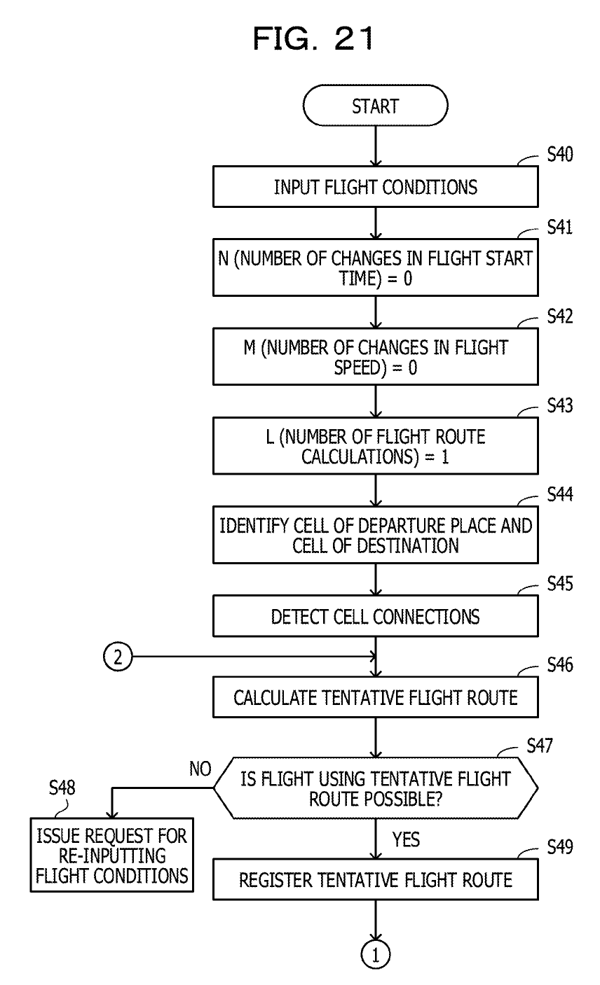

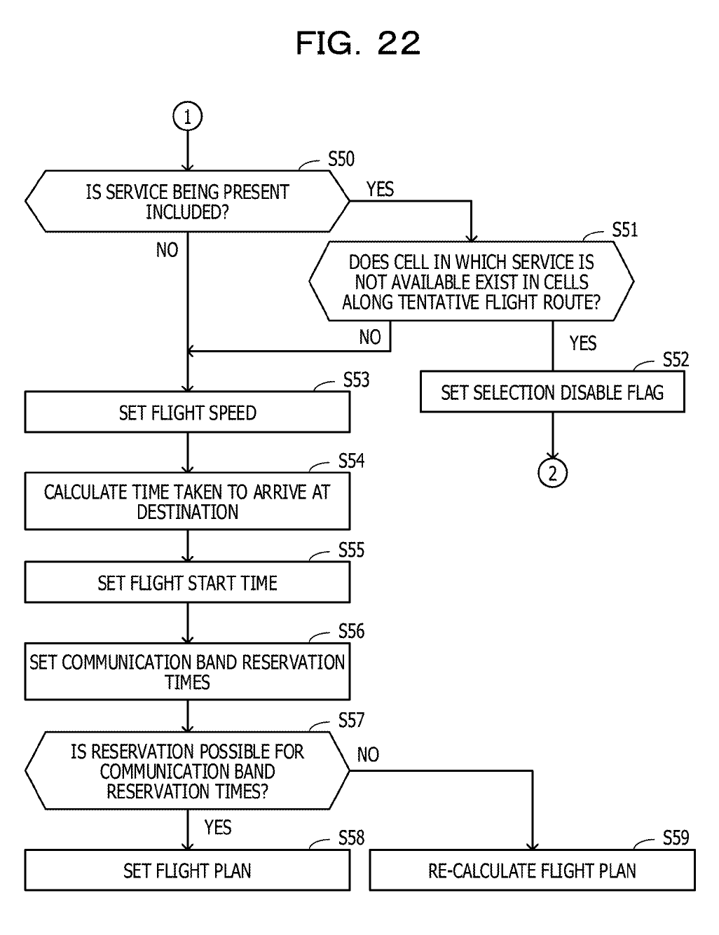

FIGS. 21 and 22 are flowcharts illustrating an operation of the flight plan calculation.

In S40, flight conditions from the client apparatus 20 are input to the flight plan manager 11.

In S41, the flight plan manager 11 sets N=0, where N represents the number of changes in the flight start time.

In S42, the flight plan manager 11 sets M=0, where M represents the number of changes in the flight speed.

In S43, the flight plan manager 11 sets L=1, where L represents the number of flight route calculations.

In S44, the flight plan manager 11 identifies a cell of a departure place and a cell of a destination.

In S45, the flight plan manager 11 recognizes cell connections from the cell of the departure place to the cell of the destination.

In S46, the flight plan manager 11 calculates a tentative flight route.

In S47, the flight plan manager 11 determines whether or not a flight using the calculated tentative flight route is possible. When the flight using the tentative flight route is not possible, the process proceeds to S48. When the flight using the tentative flight route is possible, the process proceeds to S49.

In S48, the flight plan manager 11 issues, to the client apparatus 20, a request for re-inputting flight conditions.

In S49, the flight plan manager 11 registers the tentative flight route.

In S50, the flight plan manager 11 determines whether or not the service information in the flight conditions includes a service being present. When the service being present is included in the service information, the process proceeds to S51. When the service being present is not included in the service information, the process proceeds to S53.

In S51, the flight plan manager 11 determines whether or not a cell in which the service is not available exists in the cells along the tentative flight route. When a cell in which the service is not available exists, the process proceeds to S52. When a cell in which the service is not available does not exist, the process proceeds to S53.

In S52, the flight plan manager 11 sets a selection disable flag for the cell in which the service is not available. The process then returns to S46.

In S53, the flight plan manager 11 sets a flight speed.

In S54, the flight plan manager 11 calculates a time taken to arrive at the destination.

In S55, the flight plan manager 11 sets a flight start time.

In S56, the flight plan manager 11 sets communication band reservation times.

In S57, the flight plan manager 11 requests the reservation determiner 31 to determine whether or not a reservation is possible for the communication band reservation times. When the reservation is possible, the process proceeds to S58. When the reservation is not possible, the process proceeds to S59.

In S58, the flight plan manager 11 sets a flight plan (the flight route, the flight speed, and the flight start time) and performs flight control on the drone 40.

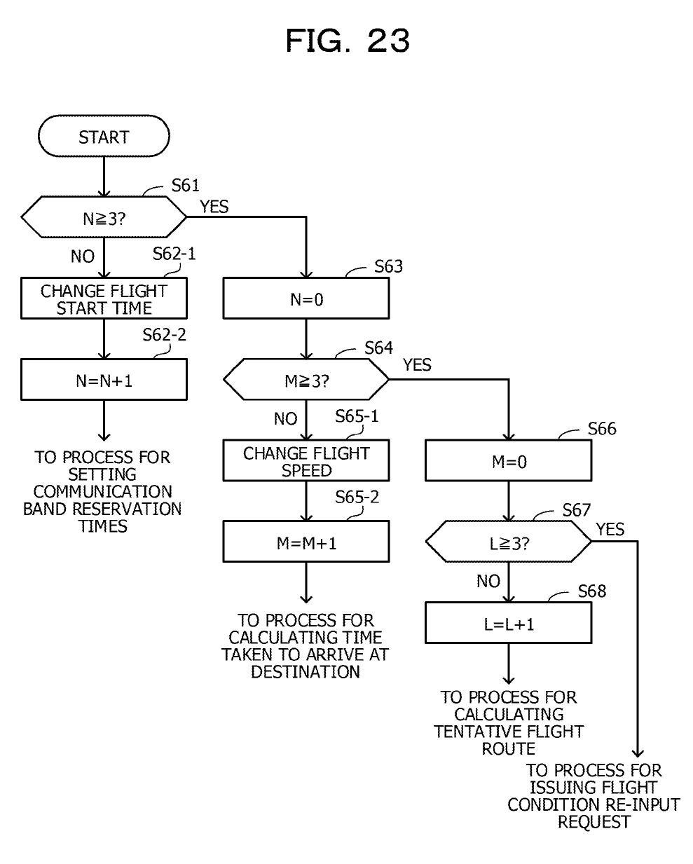

In S59, the flight plan manager 11 re-calculates the flight plan (described below with reference to FIG. 23).

<Re-Calculation of Flight Plan>

Next, a description will be given of the process illustrated in S33 in FIG. 8. When a communication band for any cell is not reservable, the flight plan manager 11 re-calculates the flight plan. For re-calculating the flight plan, the flight plan manager 11 changes at least one of the flight start time, the flight speed, and the flight route.

FIG. 23 is a flowchart illustrating an operation for re-calculating the flight plan. Although the flowchart described below illustrates a case in which the flight start time, the flight speed, and the flight route are changed in that order, the order of the changes may be any order.

In S61, the number of changes in the flight start time is indicated by N. The flight plan manager 11 determines whether or not N≥3 is satisfied. For N<3, the process proceeds to S62-1. For N≥3, the process proceeds to S63.

In S62-1, the flight plan manager 11 changes the flight start time (Ta).

In S62-2, the flight plan manager 11 increments N (N=N+1). Then, the process proceeds to the process for setting the communication band reservation times, the process being illustrated in S56 in FIG. 22.

In S63, the flight plan manager 11 sets N=0 (the process proceeds to the flight speed re-calculation).

In S64, the number of changes in the flight speed is indicated by M. The flight plan manager 11 determines whether or not M≥3 is satisfied. For M<3, the process proceeds to S65-1. For M≥3, the process proceeds to S66.

In S65-1, the flight plan manager 11 changes the flight speed (Va).

In S65-2, the flight plan manager 11 increments M (M=M+1). The process then proceeds to the process for calculating the time taken to arrive at the destination, the process being illustrated in S54 in FIG. 22.

In S66, the flight plan manager 11 sets M=0 (the process proceeds to the flight route re-calculation).

In S67, the number of flight route calculations is indicated by L. The flight plan manager 11 determines whether or not L≥3 is satisfied. For L<3, the process proceeds to S68. For L≥3, the process proceeds to the process for issuing the flight condition re-input request, the process being illustrated in S48 in FIG. 21.

In S68, the flight plan manager 11 increments L (L=L+1). The process then proceeds to process for calculating the tentative flight route, the process being illustrated in S46 in FIG. 21.

<Drone Automatic Flight Control>

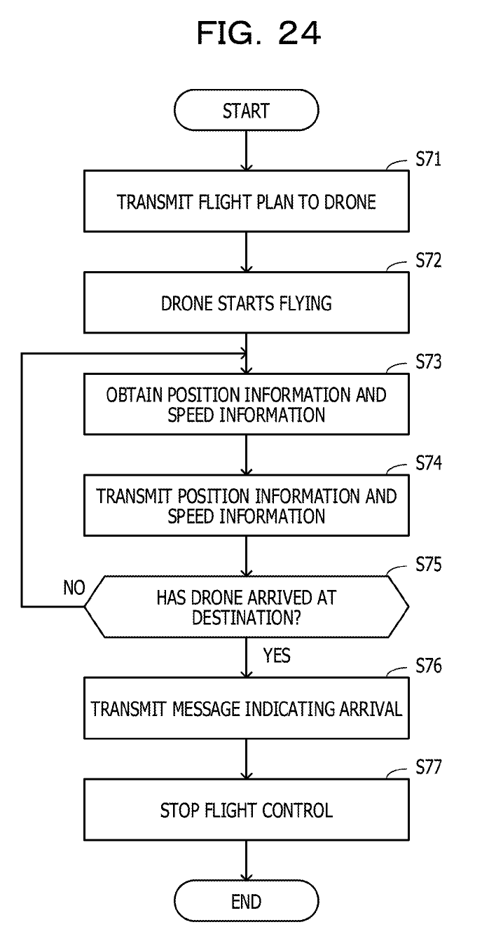

FIG. 24 is a flowchart illustrating an operation of drone automatic flight control.

In S71, when the flight start time is reached, the flight controller 12 transmits the flight plan (the flight start time, the flight speed, and the flight route information) to the drone 40.

In S72, the drone 40 starts flying.

In S73, the data measurer 43 measures and obtains position information and speed information of the drone 40 that is flying.

In S74, the data measurer 43 transmits the position information and the speed information to the flight controller 12 via the data communicator 41 at predetermined time intervals.

In S75, the fuselage controller 42 determines whether or not the drone 40 has arrived at the destination. When the drone 40 has arrived at the destination, the process proceeds to S76. When the drone 40 has not arrived at the destination, the process returns to S73.

In S76, the data communicator 41 transmits a message indicating that the drone 40 has arrived at the destination to the flight controller 12.

In S77, the flight controller 12 stops the flight control on the drone 40.

As described above, according to the present disclosure, since a communication band resource of each base station is reserved with high accuracy in a wide-range flight of a drone, a communication band for drone flight can be ensured, thus making it possible to safely fly the drone. This makes it possible to perform automatic control on wide-range flight of a drone and makes it possible to fly the drone at a scheduled time.

The processing functions of the control apparatus 1, the flight control apparatuses 10 and 10a, and the base-station management server 30 in the present disclosure described above may be realized by computers. In this case, a program in which content of processing performed by functions to be included in the control apparatus 1, the flight control apparatuses 10 and 10a, and the base-station management server 30 is written is provided. The computer executes the program, so that the processing functions are realized on the computer.

The program in which the content of processing is written may be recorded on a computer-readable recording medium. Examples of the computer-readable recording medium include a magnetic storage device, an optical disk, a magneto-optical recording medium, and a semiconductor memory.

Examples of the magnetic storage device include a hard-disk device (HDD), a floppy disk (FD), and a magnetic tape. Examples of the optical disk include a DVD, a DVD-RAM, and a CD-ROM/RW. One example of the magneto-optical recording medium is a magneto optical (MO) disk.

When the program is to be distributed, for example, portable recording media, such as DVDs or CD-ROMs, on which the program is recorded are sold. The program may be stored in a storage device in a server computer and may be transferred from the server computer to another computer through a network.

The computer that executes the program stores, for example, the program, recorded on the portable recording medium, or the program, transferred from the server computer, in a storage device of the computer. The computer then reads the program from the storage device thereof and executes processing according to the program. The computer may directly read the program from the portable recording medium and may execute processing according to the program.

Each time the program is transferred from a server computer connected through a network, the computer may sequentially execute processing according to the received program. At least one of the above-described processing functions may be realized by an electronic circuit, such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus, comprising:
a memory; and
a processor coupled to the memory and configured to:
select, from among a plurality of wireless sections that exist in a flight range from when an aerial vehicle flies from a departure place until the aerial vehicle arrives at a destination, a flight wireless section where wireless communication is connectable from the departure place to the destination; and
reserve, with wireless base stations that are located in the flight wireless section, a communication band for performing wireless communication with the aerial vehicle.

2. The control apparatus according to claim 1, wherein the control apparatus is configured to:
determine, when flight conditions of the aerial vehicle include executing a predetermined communication service between the wireless base stations and the aerial vehicle, whether or not the communication service is executable in the communication band of the wireless base stations;
disable, when determining that a service-inexecutable wireless base station by which the communication service is not executable is included in the wireless base stations, selection of a service-inexecutable flight wireless section including the service-inexecutable wireless base station; and
select the flight wireless section excluding the service-inexecutable flight wireless section from the wireless sections.

3. The control apparatus according to claim 1, wherein the control apparatus is configured to:
further perform flight control on the aerial vehicle;
set a flight speed of the aerial vehicle;
set a flight route along which the aerial vehicle passes through the flight wireless section;
calculate a time taken to arrive at the destination, based on a distance of the flight route and the flight speed;
set flight reaching points by dividing the flight route by a predetermined distance and calculate, for each flight reaching point, a reaching time from when the aerial vehicle starts flying until the aerial vehicle reaches the flight reaching point; and
calculate a flight start time of the aerial vehicle, based on the calculated time taken and an arrival time at the destination, the arrival time being included in the flight conditions of the aerial vehicle.

4. The control apparatus according to claim 3, wherein the control apparatus is configured to:
when the aerial vehicle flies from a first flight wireless section including the departure place to a third flight wireless section including the destination via a second flight wireless section,
use a flight start time when the aerial vehicle takes off at the departure place as a communication band reservation start time for the first flight wireless section, and use a first reaching time at a first flight reaching point, which is a first flight reaching point that the aerial vehicle reaches in the second flight wireless section, as a communication band reservation end time for the first flight wireless section;
use a second reaching time at a second flight reaching point, which is a last flight reaching point that the aerial vehicle reaches in the first flight wireless section, as a communication band reservation start time for the second flight wireless section, and use a third reaching time at a third flight reaching point, which is a first flight reaching point that the aerial vehicle reaches in the third flight wireless section, as a communication band reservation end time for the second flight wireless section; and
use a fourth reaching time at a fourth flight reaching point, which is a last flight reaching point that the aerial vehicle reaches in the second flight wireless section, as a communication band reservation start time for the third flight wireless section, and use a flight end time when the aerial vehicle lands at the destination as a communication band reservation end time for the third flight wireless section.

5. The control apparatus according to claim 4, wherein the control apparatus is configured to
perform flight control on the aerial vehicle based on a communication band reservation time from one of the communication band reservation start times to the corresponding communication band reservation end time, when the communication band reservation time is included in a time segment in which a communication band in the corresponding flight wireless section is usable, and the number of aerial vehicles that fly in the communication band reservation time does not exceed an allowable value set for the flight wireless section.

6. The control apparatus according to claim 4, wherein the control apparatus is configured to:
perform change processing including at least one of changing the flight start time, changing the flight speed, and changing the flight wireless section a predetermined number of times, when a communication band reservation time from one of the communication band reservation start times to the corresponding communication band reservation end time is not included in a time segment in which a communication band in the corresponding flight wireless section is usable, or the number of aerial vehicles that fly in the communication band reservation time exceeds an allowable value set for the flight wireless section; and
issue, to a client side, a request for re-inputting a flight condition of the aerial vehicle, when the communication band reservation time is not determined in the change processing performed the predetermined number of times.

7. An aerial-vehicle control method executed by a processor in a control apparatus, the aerial-vehicle control method comprising:
selecting, in a plurality of wireless sections that exist in a flight range from when an aerial vehicle flies from a departure place until the aerial vehicle arrives at a destination, a flight wireless section where wireless communication is connectable from the departure place to the destination; and
reserving, with wireless base stations that are located in the flight wireless section, a communication band for performing wireless communication with the aerial vehicle.

8. The aerial-vehicle control method according to claim 7, further comprising:
determining, when flight conditions of the aerial vehicle include executing a predetermined communication service between the wireless base stations and the aerial vehicle, whether or not the communication service is executable in the communication band of the wireless base stations;
disabling, when determining that a service-inexecutable wireless base station by which the communication service is not executable is included in the wireless base stations, selection of a service-inexecutable flight wireless section including the service-inexecutable wireless base station; and
selecting the flight wireless section excluding the service-inexecutable flight wireless section from the wireless sections.

9. The aerial-vehicle control method according to claim 7, further comprising:
performing flight control on the aerial vehicle;
setting a flight speed of the aerial vehicle;
setting a flight route along which the aerial vehicle passes through the flight wireless section;
calculating a time taken to arrive at the destination, based on a distance of the flight route and the flight speed;
setting flight reaching points by dividing the flight route by a predetermined distance and calculate, for each flight reaching point, a reaching time from when the aerial vehicle starts flying until the aerial vehicle reaches the flight reaching point; and
calculating a flight start time of the aerial vehicle, based on the calculated time taken and an arrival time at the destination, the arrival time being included in the flight conditions of the aerial vehicle.

10. The aerial-vehicle control method according to claim 9, further comprising:
when the aerial vehicle flies from a first flight wireless section including the departure place to a third flight wireless section including the destination via a second flight wireless section,
using a flight start time when the aerial vehicle takes off at the departure place as a communication band reservation start time for the first flight wireless section, and use a first reaching time at a first flight reaching point, which is a first flight reaching point that the aerial vehicle reaches in the second flight wireless section, as a communication band reservation end time for the first flight wireless section;
using a second reaching time at a second flight reaching point, which is a last flight reaching point that the aerial vehicle reaches in the first flight wireless section, as a communication band reservation start time for the second flight wireless section, and use a third reaching time at a third flight reaching point, which is a first flight reaching point that the aerial vehicle reaches in the third flight wireless section, as a communication band reservation end time for the second flight wireless section; and
using a fourth reaching time at a fourth flight reaching point, which is a last flight reaching point that the aerial vehicle reaches in the second flight wireless section, as a communication band reservation start time for the third flight wireless section, and use a flight end time when the aerial vehicle lands at the destination as a communication band reservation end time for the third flight wireless section.

11. The aerial-vehicle control method according to claim 10, further comprising
performing flight control on the aerial vehicle based on a communication band reservation time from one of the communication band reservation start times to the corresponding communication band reservation end time, when the communication band reservation time is included in a time segment in which a communication band in the corresponding flight wireless section is usable, and the number of aerial vehicles that fly in the communication band reservation time does not exceed an allowable value set for the flight wireless section.

12. The aerial-vehicle control method according to claim 10, further comprising:
performing change processing including at least one of changing the flight start time, changing the flight speed, and changing the flight wireless section a predetermined number of times, when a communication band reservation time from one of the communication band reservation start times to the corresponding communication band reservation end time is not included in a time segment in which a communication band in the corresponding flight wireless section is usable, or the number of aerial vehicles that fly in the communication band reservation time exceeds an allowable value set for the flight wireless section; and
issuing, to a client side, a request for re-inputting a flight condition of the aerial vehicle, when the communication band reservation time is not determined in the change processing performed the predetermined number of times.

13. A non-transitory computer-readable storage medium having stored therein a program for controlling an aerial vehicle, the program executing a process comprising:
selecting, in a plurality of wireless sections that exist in a flight range from when an aerial vehicle flies from a departure place until the aerial vehicle arrives at a destination, a flight wireless section where wireless communication is connectable from the departure place to the destination; and
reserving, with wireless base stations that are located in the flight wireless section, a communication band for performing wireless communication with the aerial vehicle.
